(19) United States
(12) Patent Application Publication
(10) Pub. No.: US 2016/0003214 A1
(43) Pub. Date: Jan. 7, 2016

(54) OPTIMIZED HEAVE PLATE FOR WAVE ENERGY CONVERTER

(71) Applicant: Oscilla Power, Inc., Seattle, WA (US)

(72) Inventors: Timothy R Mundon, Seattle, WA (US); Zachary Murphree, Dallas, TX (US); Antoine Peiffer, Oakland, CA (US)

(73) Assignee: OSCILLA POWER, INC., Seattle, WA (US)

(21) Appl. No.: 14/855,134

(22) Filed: Sep. 15, 2015

Related U.S. Application Data
(63) Continuation-in-part of application No. 13/928,035, filed on Jun. 26, 2013, now Pat. No. 9,169,823.
Application No. 13/928,035 is a continuation-in-part of application No. 14/808,436, filed on Jul. 24, 2015.
(60) Provisional application No. 62/050,748, filed on Sep. 15, 2014.
(60) Provisional application No. 61/664,444, filed on Jun. 26, 2012.
(60) Provisional application No. 62/028,582, filed on Jul. 24, 2014.

(51) Int. Cl. F03B 13/22; E02B 9/08

(52) U.S. Cl. CPC F03B 13/22; E02B 9/08

(57) ABSTRACT

A device for converting wave energy includes a surface float, a heave plate, at least one load carrying structure that is mechanically coupled to at least one component of at least one generator on the surface float and the heave plate. The heave plate has an asymmetric geometry to facilitate a first level of resistance to movement in an upward direction and a second level of resistance in a downward direction. The first level of resistance is higher than the second level of resistance. The at least one load carrying structure includes a flexible tether. The at least one component is configured to experience force changes caused by hydrodynamic forces acting on the surface float and heave plate.

### CROSS-REFERENCE TO RELATED APPLICATIONS

This application claims the benefit of U.S. Provisional Application No. 62/050,748, filed on Sep. 15, 2014 (docket no. OSC-P029P). This application also is a continuation-in-part of U.S. application Ser. No. 13/928,035, filed on Jun. 26, 2013 (docket no. OSC-P016), which claims the benefit of priority of U.S. Provisional Application No. 61/664,444, filed on Jun. 26, 2012 (docket no. OSC-P016P). This application also is a continuation-in-part of U.S. application Ser. No. 14/808,436, filed on Jul. 24, 2015 (docket no. OSC-P028), which claims the benefit of priority of U.S. Provisional Application No. 62/028,582, filed on Jul. 24, 2014 (docket no. OSC-P028P). Each of these references is incorporated by reference herein in their entirety.

### STATEMENT OF FEDERALLY SPONSORED RESEARCH

This invention was made with Government support under DE-SC0010232 and DE-SC0006352 awarded by the Department of Energy. The Government has certain rights to this invention.

### BACKGROUND

Heave plates (aka baffle plates or water entrapment plates) have been used extensively in the offshore space in order to damp the heave response of a body in a wave environment. The principle of operation is that the large plates, which are disposed such that their largest projected area is in a plane that is perpendicular to the heave direction, are attached below the surface of the water to limit (e.g., delay, dampen, decrease, etc.) motion in the heave direction. This adds to the effective mass of the system by adding a considerable drag force to the system at the location of the plate. In order for the plate to move in heave, the water around the plate must also be accelerated.

### SUMMARY

Embodiments of a device for converting wave energy are described. In one embodiment the device for converting wave energy includes a surface float, a heave plate, at least one load carrying structure that is mechanically coupled to at least one component of at least one generator on the surface float and the heave plate. The heave plate has an asymmetric geometry to facilitate a first level of resistance to movement in an upward direction and a second level of resistance in a downward direction. The first level of resistance is higher than the second level of resistance. The at least one load carrying structure includes a flexible tether. The at least one component is configured to experience force changes caused by hydrodynamic forces acting on the surface float and heave plate.

Embodiments of a method for converting wave energy are described. In one embodiment, the method for converting wave energy includes utilizing the motion of a body of water to apply hydrodynamic forces on a surface float and a heave plate, resulting in forces being applied to at least one generator mounted within the surface float resulting in electric power production by the generator. The generators are deployed within a surface float are mechanically coupled to a heave plate by at least one flexible tether. The heave plate includes an asymmetric geometry to facilitate a first level of resistance to movement in an upward direction and a second level of resistance in a downward direction. The first level of resistance is higher than the second level of resistance. Other embodiments of methods for converting wave energy are also described.

Embodiments of a device for converting wave energy to electrical energy are described. In one embodiment, the device for converting wave energy includes a surface float, a heave plate, at least three load carrying structures each of which are mechanically coupled to both the heave plate on one side and to at least one component of at least one generator mounted within the surface float on the other end. The at least three load carrying structures each include a flexible tether. The at least one component of at least one generator is configured to experience force changes caused by hydrodynamic forces acting on the surface float and heave plate.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts an embodiment of a device for generating electricity for use with a heave plate.

FIG. 2 depicts one embodiment of a device for generating electricity with an asymmetric heave plate.

FIG. 3 depicts one embodiment of a device for generating electricity with an asymmetric heave plate from an alternate view.

FIG. 4 depicts one embodiment of a device for generating electricity with a slack safety line between the heave plate and the buoy.

FIG. 5 depicts one embodiment of an optimization surface showing a maximum balance of moment of inertia and mass ratios between a heave plate and a surface float that will maximize energy captured within a system.

FIG. 6 depicts one embodiment of a resulting RAO, with the top plot showing overall power response against frequency and the bottom plot showing heave and pitch power response.

FIG. 7 depicts a schematic diagram of one embodiment of a surface float and a heave plate tethered by flexible tethers.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

Heave plates (aka baffle plates or water entrapment plates) have been used extensively in the offshore space in order to damp the heave response of a body in a wave environment. The principle of operation is that the large plates, which are disposed such that their largest projected area is in a plane that is perpendicular to the heave direction, are attached below the surface of the water to limit (e.g., delay, dampen, decrease, etc.) motion in the heave direction. This increases the added mass of the system by adding a considerable drag force to the system at the location of the plate. In order for the plate to move in heave, the water around the plate must also be accelerated. The area and configuration of the plate are designed in order to optimize this increase in added mass. This increase lowers the natural frequency of the system, and essentially creates a high-pass filter that will respond to very low frequency waves (i.e., tidal waves), but not significantly to the regular ocean waves caused by wind. The heave plate is also generally disposed at a depth where the motion of the waves is much more attenuated than at the surface. In some embodiments, the heave plate is disposed at a depth greater than 10 meters below the water surface.

Heave plates can be used in wave energy converters (WECs) to provide what is essentially an inertial reference for the device other than the ocean floor. This is important because WECs rely on relative motion caused by waves to produce energy. WEC systems that have used this concept in the past are spar buoys that include a heave plate as part of the spar structure, where the heave plate and spar buoy move relative to each other to create energy.

Embodiments described herein relate to a wave energy converter system with a heave plate. In some embodiments, the heave plate may be referred to as an optimized heave plate, wherein the optimization refers to a relative improvement over conventional heave plate implementations.

Some embodiments are related to a wave energy converter system where the heave plate has a moment of inertia in at least one mode of motion (e.g. pitch, roll, yaw, heave, sway, surge, etc.) that is significantly different than at least one surface float. In some embodiments, the heave plate may have moment of inertia in at least one mode of motion that is over 2 times that of at least one surface float. In other embodiments, the heave plate may have moment of inertia in at least one mode of motion that is over 5 times that of at least one surface float. In some preferred embodiments of the invention, the added mass of the heave plate may be over 2 times, and preferably over 5 times that of at least one surface float.

In some embodiments, the added mass of the heave plate may be over 2 times that of at least one surface float, and simultaneously a heave plate may have moment of inertia in at least one mode of motion that is over 2 times that of at least one surface float. In other embodiments, the added mass of the heave plate may be over 5 times that of at least one surface float, and simultaneously a heave plate may have moment of inertia in at least one mode of motion that is over 5 times that of at least one surface float.

One embodiment of a magnetostrictive wave energy harvester includes of a large float at the ocean surface tethered to a deeply submerged heave plate. The surface float reacts against the submerged heave plate to generate tension changes in the tethers, which are transmitted to magnetostrictive generators to produce power.

Conventional uses of heave plates typically focus largely on heave plates for offshore spar platforms used in the oil and gas industry. The primary areas of interest for offshore platforms were numerical simulation and experimental modeling to investigate the effects of a variety of parameters on heave plate performance. These parameters include plate thickness to width ratio, shape of plate edge, plate depth, oscillation frequency, effects of Keulegan-Carpenter number, hole size, and perforation ratio. Some design parameters and/or approaches from conventional heave plate implementations, including some aspects of methodology and modeling techniques, may be useful in the design of heave plates for embodiments of magnetostrictive wave energy harvesters.

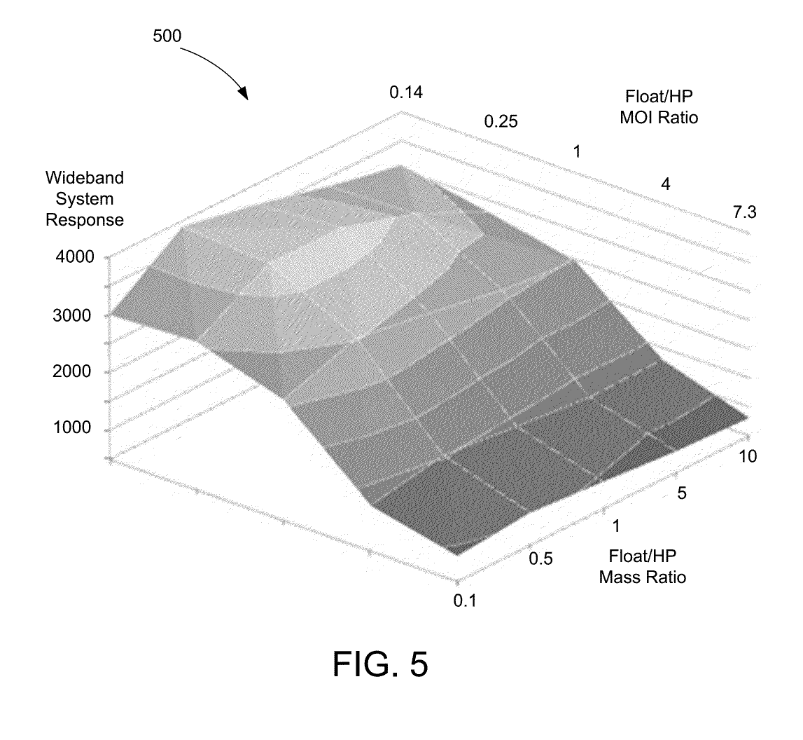

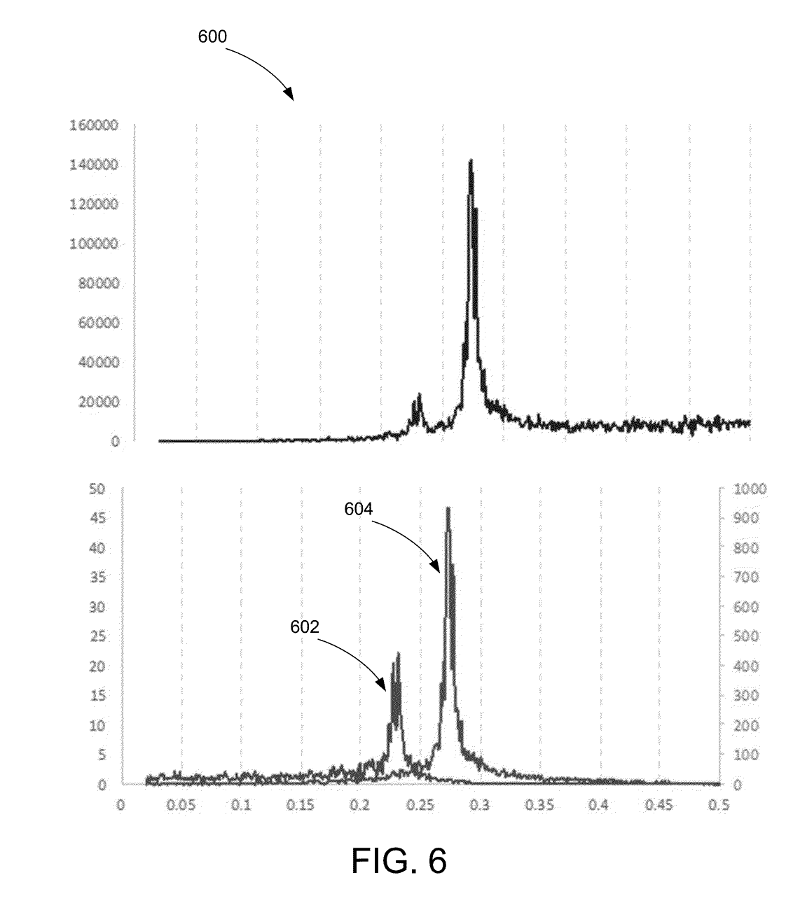

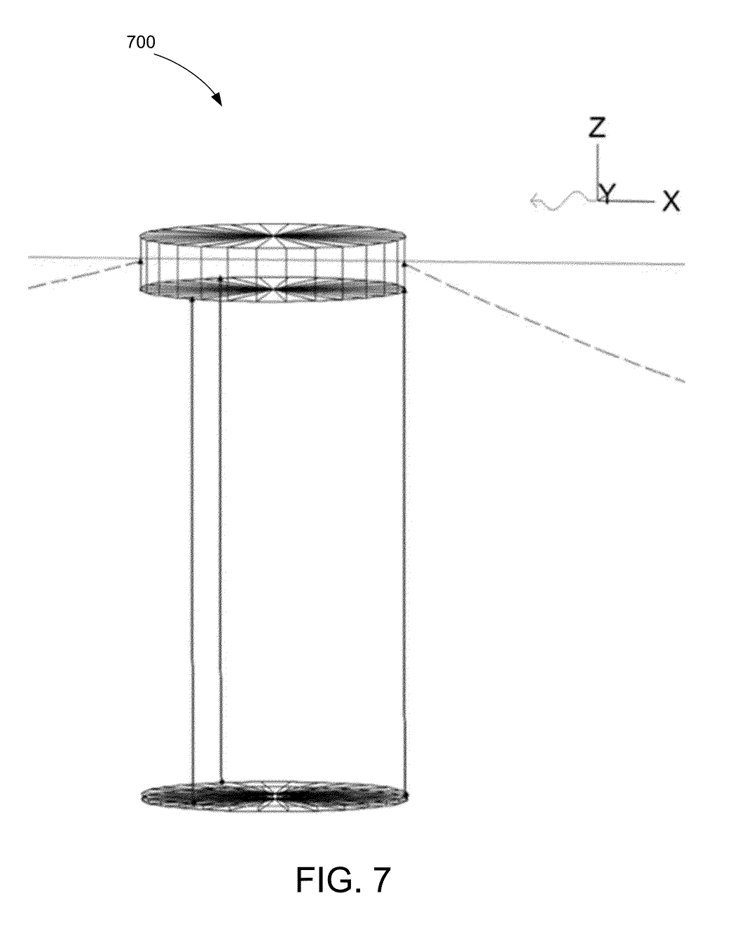

A difference between new designs and conventional designs, typically used in the oil and gas industry (as well as in other wave energy devices), is that new designs of heave plate implementations are not rigidly connected to the surface float, but rather attached with multiple flexible tethers. This facilitates incorporation of multiple discrete generator units in the tethers. In some embodiments, generator units are disposed on the surface float or within the surface float. In some embodiments, the flexible tethers are connected or otherwise mechanically coupled to a component of the generator. Additionally, the inclusion of multiple flexible tethers also has the potential to increase energy capture in additional movement modes. In a system with a surface float tethered to the seafloor (i.e., no heave plate), energy capture would be effectively heave-limited, with buoyancy driven force changes driving the extracted energy. By moving to a self-referencing system with a heave plate (see FIG. 7), the surface float reacts against the heave plate whose motion is limited by its mass properties and geometry. This additional freedom of motion limits the heave forces that can be generated when compared to a fixed reference. However, by establishing the mass properties of the heave plate and surface float accordingly, the wave induced pitch motion may be used to generate significant alternating forces in the tethers. An aspect of this mode of capture involves setting the ratio of moment of inertia ratio between the heave plate and surface float as shown in FIG. 5 with the resulting RAO shown in FIG. 6.

An additional observed effect of using a non-rigidly mounted heave plate is that in large sea states there is a tendency for slack events to occur in the tethers. Such events should be avoided in order to minimize unpredictable shock loading. Some embodiments are able to increase the static mass of the heave plate so that slack events cannot occur; however some modeling indicates that this may result in an unacceptably heavy structure. As an alternative, the geometry of the heave plate can be varied to provide increased hydrodynamic mass properties in an asymmetric form that would allow a physically lighter structure to provide the same reaction forces as compared to a much heavier symmetrical structure.

An embodiment of a device is a taut-moored concept that could benefit greatly from the use of heave plates. This is different from conventional spar buoy implementations because the taut-moored implementation relies on the damped motion of the heave plate to create tension changes in the tether (not on the large relative motions necessary for other systems to create energy).

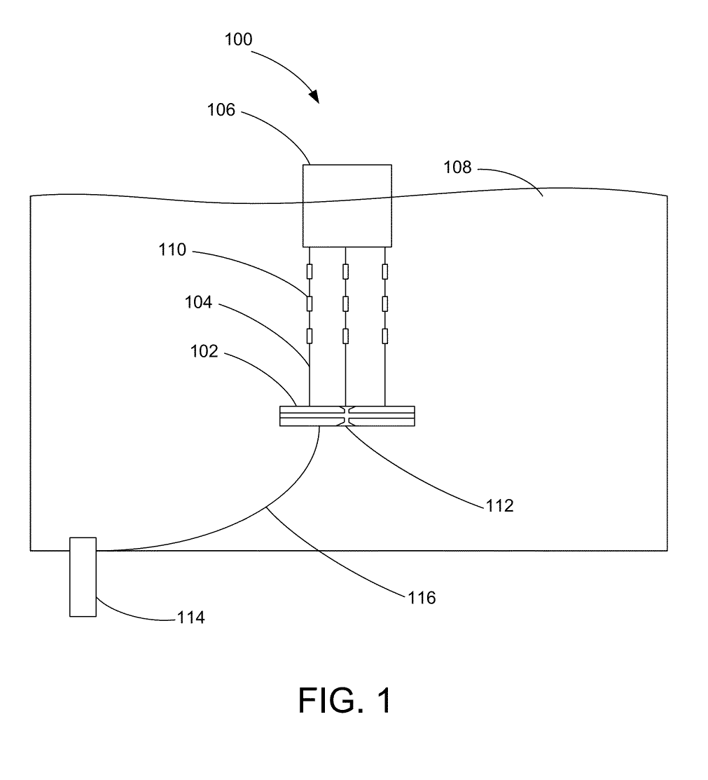

FIG. 1 depicts an embodiment of a device 100 for generating electricity for use with a heave plate 102. In one embodiment, the heave plate 102 is a simple plate with taut tether(s) 104 extending upwards that connect to a surface float 106, floating in water 108. The plate 102 may be either a solid surface, or may contain perforations 112 or be perforated such that water 108 can flow through it, albeit it in a restricted manner.

One or more power take-off (PTO) modules 110 may be deployed in the float 106, along the tether 104, at the heave plate 102, or a combination of any of these three. The tether system allows this heave plate 102 to be deployed deeper than those that are rigidly fixed to the buoy 106, which increases the effect of the heave damping. In one embodiment, the mass of the heave plate 102 is balanced against the buoyancy of the surface float 106 in order to maintain a tensile load in the tethers 104 across all expected wave conditions. The frequency response of this system is also tuned such that the plate 102 does not respond to waves during normal operation, but will move in order to fully or partially accommodate extreme wave events, and will respond the very low frequency events such as tidal variation. In some embodiments, the heave plate has a natural period that is higher than the period of the most prevalent wave at the site in which the device is deployed. In some embodiments, the heave plate has a natural period that is at least 1.5 times higher than the period of the most prevalent wave at the site in which the device is deployed. FIG. 1 also depicts an anchor 114 connected 116 to the heave plate 102.

The heave plate configuration greatly simplifies the mooring system of a taut-moored PTO module. The plate allows replacement of one or more mooring points on the ocean floor with a single (or multiple) catenary system. Without the heave plate, the mooring itself must carry the entire load present in the tethers, which requires substantial engineering effort. The heave plate system allows for the mooring point(s) to be sized in order to perform at a level sufficient for station-keeping, but does not have to carry the entire load.

The taut moorings of an embodiment of the system require that the tethers 104 always be maintained in tension. The highest probability of system failure occurs if the tethers are ever allowed to go slack. As the tension is reestablished after such a “slack event”, a snap load will be applied to the system with potentially catastrophic consequences. Some embodiments utilize flexible tethers to reduce or eliminate slack events. This also allows the surface float and the heave plate to rotate independently from each other and allows for maximizing and optimizing power capture of more than just a heave mode of motion. The heave plate 102 can be further tailored to help avoid such events. This may be accomplished by making the response of the heave plate asymmetric, such that the heave plate responds differently when the applied motion is up or down.

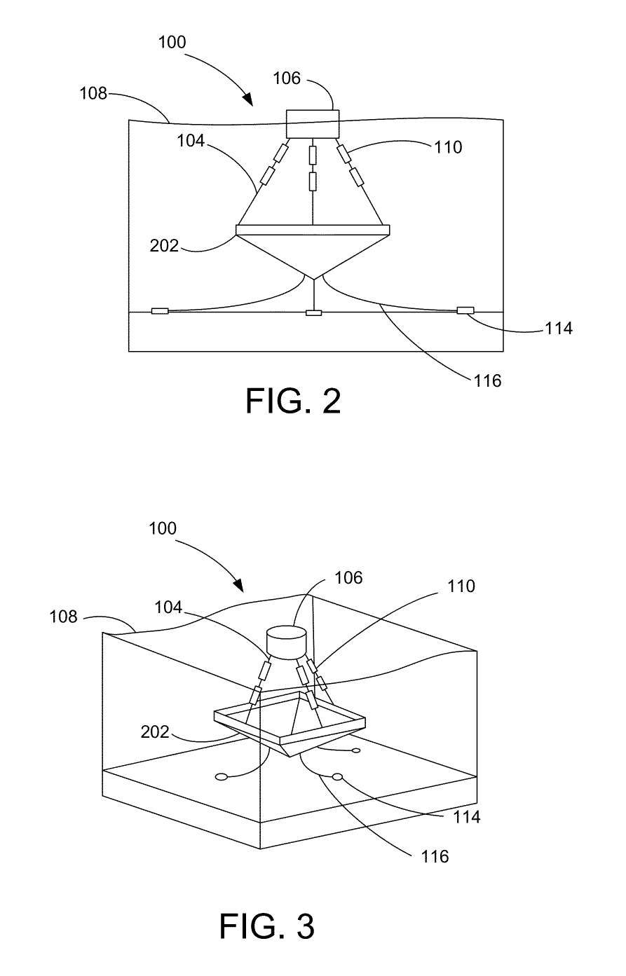

FIG. 2 depicts one embodiment of a device 100 for generating electricity with an asymmetric heave plate 202. In one embodiment, a plate 202 is more streamlined in one direction, i.e., the coefficient of drag is lower when the plate motion is in one direction. This configuration might look similar to that depicted in FIG. 2. In this figure, the plate entraps a significantly larger volume of water when the buoy 106 is pulling it towards the surface (the added mass of the displaced water with the plate is very large), but the plate 202 can move more easily downward as the tension is decreased (the added mass of the displaced water with the plate is relatively small in the downward direction). This allows the plate 202 to fall through the water more easily than it can rise, which may allow the system to accommodate more extreme wave events. If the buoy were to go from crest to trough in an extreme wave, this asymmetric design would allow the plate to accelerate downward, which would aid in maintaining a tensile load on the tethers, and therefore increase survivability.

In one embodiment, the perforations 112 that are mentioned in the description of the symmetric plate 102 could also be tailored to be asymmetric 202, such that the perforations 112 themselves restrict the flow of water 108 in one direction more than the other. This could be accomplished by a specific orientation of angle-iron or some other three-dimensional plate configuration.

FIG. 3 depicts one embodiment of a device 100 for generating electricity with an asymmetric heave plate 202 from an alternate view. FIG. 3 depicts many of the same features as FIGS. 1 and 2.

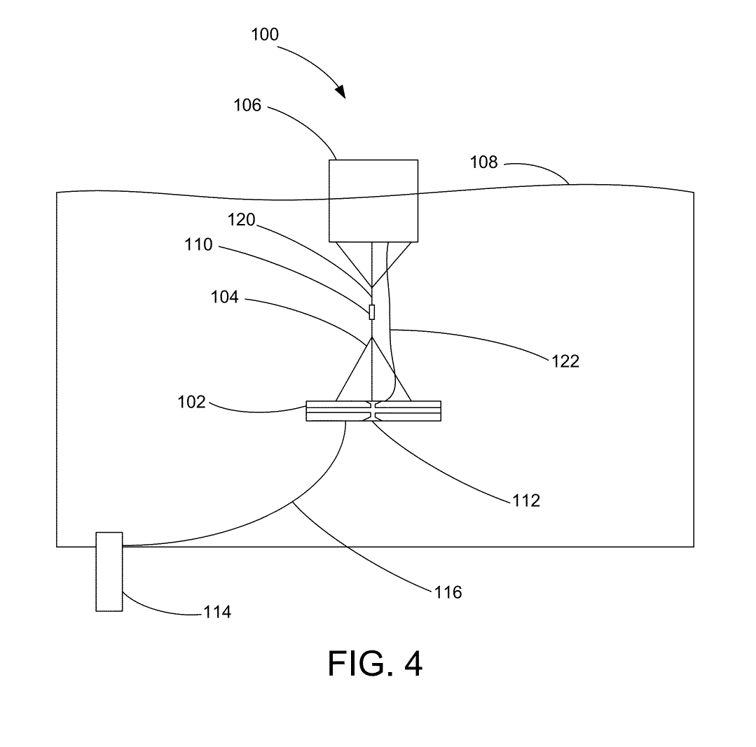

FIG. 4 depicts one embodiment of a device 100 for generating electricity with a slack safety line 122 between the heave plate 102 and the buoy 106. In some embodiments, the configuration may also be modified to accommodate any number of PTO modules, for example, a single large PTO module 110, as shown in FIG. 4. In this case, there are multiple tethers 104 from the edge of both the heave plate 102 and the buoy 106 that merge into a single line 120 before attaching to the PTO 110. This enhances the stability of both the plate 102 and buoy 106 by constraining some of their respective pitch and roll motions. Alternatively, depending on the design of the heave plate 102 and supporting structural elements, there may be fewer (e.g., a single tether) or more tethers connected to the heave plate structure. This embodiment also includes a slack safety line 122 between the heave plate 102 and the buoy 106 that would only engage in the event that the taut connection between the plate 102 and buoy 106 failed.

Some embodiments of the present invention comprise a device for generating electricity, the device comprising: at least one magnetostrictive element, at least one buoyant device (or buoy), at least one heave plate and when deployed in a body of water, the interaction of waves with at least one buoy causes changes in the strain of one or more magnetostrictive elements; and one or more electrically conductive coils or circuits within the vicinity of one or more of the magnetostrictive elements, wherein a corresponding change in magnetic flux density in the one or more magnetostrictive elements generates an electric voltage and/or electric current in the one or more electrically conductive coils or circuits, wherein there is no substantial relative motion between the one or more magnetostrictive elements and the one or more electrically conductive coils or circuits.

Some embodiments may further comprise at least one anchor device located in a substantially fixed location below a surface of the body of water, wherein a first end of the buoy or a first end of the heave plate is coupled to the anchor device.

Some embodiments may further comprise at least one rigid tether coupled between the one or more magnetostrictive elements and the buoyant device. Some embodiments may further comprise at least one flexible tether coupled between the one or more elements. In some embodiments, the elements are not magnetostrictive elements.

Some embodiments may comprise at least one battery coupled to the one or more electrically conductive coils or circuits, the battery to store at least some of the electrical energy generated in the one or more electrically conductive coils or circuits.

In some embodiments, the at least one magnetostrictive element may be part of at least one magnetic flux path.

In some preferred embodiments, the at least one magnetostrictive element may be part of at least one substantially closed magnetic flux path with all components in the flux path having a relative permeability in excess of 10. In some preferred embodiments, the at least one magnetostrictive element may be part of at least one substantially closed magnetic flux path with all components in the flux path having a relative permeability in excess of 50.

In some embodiments, each of the one or more magnetostrictive elements comprises a magnetostrictive rod.

In some embodiments, at least one electrically conductive coil or circuit comprises a polymer coated copper coil wrapped around the magnetostrictive rod.

Some embodiments of the present invention comprise a method for generating electricity, the method comprising: utilizing the motion of a body of water, including wave motion, to cause changes in the strain of one or more magnetostrictive elements deployed with one end mechanically coupled to a buoyant device (or buoy) and the other end mechanically coupled to a heave plate; and using a corresponding change in magnetic flux density in the magnetostrictive elements to generate an electric voltage and/or electric current in one or more electrically conductive coils or circuits that are in the vicinity of the magnetostrictive elements, wherein there is no substantial relative motion between the one or more magnetostrictive elements and the one or more electrically conductive coils or circuits.

Some embodiments comprise utilizing the motion of the body of water, including the wave motion, comprises utilizing motion of one or more buoys, which in turn causes changes in the strain of one or more magnetostrictive elements to which one or more buoys and/or heave plates may be coupled mechanically; and using a corresponding change in magnetic flux density in the magnetostrictive elements to generate an electric voltage and/or electric current in one or more electrically conductive coils or circuits that are in the vicinity of the magnetostrictive elements.

Some embodiments comprise a device for generating electricity, wherein the device comprises: a buoy deployed in a body of water; a magnetostrictive element mechanically coupled to at least one buoy and at least one heave plate, wherein the motion of the body of water, including wave motion, causes motion of the buoy, which in turn causes changes in the strain of the magnetostrictive element; and an electrically conductive coil or circuit within the vicinity of the magnetostrictive element, wherein a corresponding change in magnetic flux density in the magnetostrictive element generates an electric voltage and/or electric current in the electrically conductive coil or circuit, wherein there is no substantial relative motion between the one or more magnetostrictive elements and the one or more electrically conductive coils or circuits.

FIG. 5 depicts one embodiment of an optimization surface showing a maximum balance of moment of inertia and mass ratios between a heave plate and a surface float that will maximize energy captured within a system. Changing the ratio of the moment of inertias of the heave plate and surface float affect the energy captured by a device as the modes of motion of the surface float and the heave plate with create oscillating. This also occurs by changing the mass ratio between the surface float and the heave plate. As is shown in FIG. 5, energy captured is maximized when the ratio of the moment of inertia of the surface float and the moment of inertia of the heave plate is below 1.0.

FIG. 6 depicts one embodiment of a resulting RAO, with the top plot showing overall power response against frequency and the bottom plot showing heave and pitch power response. The bottom plot depicts the heave power response 602 and the pitch power response 604.

FIG. 7 depicts a schematic diagram of one embodiment of a surface float and a heave plate tethered by flexible tethers. The flexible tethers allow for the surface float and the heave plate to move out of sequence during the various modes of motion that a surface float and heave plate would be subjected to.

Other embodiments may incorporate one or more other aspects from related descriptions, including the subject matter described and shown in U.S. application Ser. No. 13/541,250, filed on Jul. 3, 2012, and entitled “Apparatus for Harvesting Electrical Power from Mechanical Energy,” which is incorporated herein in its entirety.

In the above description, buoyant structure, buoyant device, and surface float are sometimes used interchangeably.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A device for converting wave energy, the device comprising:
a surface float;
a heave plate having an asymmetric geometry to facilitate a first level of resistance to movement in an upward direction and a second level of resistance in a downward direction, wherein the first level of resistance is higher than the second level of resistance; and
at least one load carrying structure mechanically coupled to at least one component of at least one generator on the surface float and to the heave plate,
the at least one load carrying structure comprising a flexible tether,
wherein the at least one component is configured to experience force changes caused by hydrodynamic forces acting on the surface float and heave plate.

2. The device of claim 1, wherein a ratio of a moment of inertia of the surface float in at least one mode of motion and a moment of inertia of the heave plate in that same mode of motion is below 1.0.

3. The device of claim 1, wherein a ratio of a moment of inertia of the surface float in at least one mode of motion and a moment of inertia of the heave plate in that same mode of motion is below 0.25.

4. The device in claim 1, wherein the heave plate is disposed at a depth greater than 10 meters below the water surface.

5. The device of claim 1, further comprising at least one anchor device coupled to the device, wherein the anchor device is configured to provide station-keeping of the device relative to an anchor point.

6. The device of claim 1, wherein the heave plate has a natural period that is at least 1.5 times higher than the period of the most prevalent wave at the site in which the device is deployed for at least one mode of motion.

7. The device of claim 1, where the device comprises at least three load carrying structures each comprising at least one flexible tether and a generator.

8. A method for converting wave energy, the method comprising:
utilizing the motion of a body of water to apply hydrodynamic forces on a surface float and a heave plate, resulting in forces being applied to at least one generator mounted within the surface float resulting in electric power production by the generator,
wherein the generators are deployed within a surface float are mechanically coupled to a heave plate by at least one flexible tether,
wherein the heave plate comprises an asymmetric geometry to facilitate a first level of resistance to movement in an upward direction and a second level of resistance in a downward direction, wherein the first level of resistance is higher than the second level of resistance.

9. The method of claim 8, wherein a ratio of a moment of inertia of the surface float in at least one mode of motion and a moment of inertia of the heave plate in the same mode of motion is below 1.0.

10. The method of claim 8, wherein a ratio of the moment of inertia of the surface float in at least one mode of motion and the moment of inertia of the heave plate in the same mode of motion is below 0.25.

11. The method in claim 8, wherein the heave plate is disposed at a depth greater than 10 meters below the water surface.

12. The method of claim 8, further comprising at least one anchor device coupled to the device, wherein the anchor device is configured to provide station-keeping of the device relative to an anchor point.

13. The method of claim 8, wherein the heave plate has a natural period that is at least 1.5 times higher than the period of the most prevalent wave at the site in which the device is deployed for at least one mode of motion.

14. The method of claim 8, where the device comprises at least three load carrying structures each comprising at least one flexible tether and a generator.

15. A device for converting wave energy to electrical energy, the device comprising:
a surface float;
a heave plate;
at least three load carrying structures each of which are mechanically coupled to both the heave plate on one side and to at least one component of at least one generator mounted within the surface float on the other end, the at least three load carrying structures each comprising a flexible tether; and
the at least one component of at least one generator is configured to experience force changes caused by hydrodynamic forces acting on the surface float and heave plate.

16. The device of claim 15, wherein the ratio of the moment of inertia of the surface float in at least one mode of motion and the moment of inertia of the heave plate in the same mode of motion is less than 1.0.

17. The device of claim 15, wherein the ratio of the moment of inertia of the surface float in at least one mode of motion and the moment of inertia of the heave plate in the same mode of motion is less than 0.25.

18. The device in claim 15, wherein the heave plate is disposed at a depth greater than 10 meters below the water surface.

19. The device of claim 15, further comprising at least one anchor device coupled to the device, wherein the anchor device is configured to provide station-keeping of the device relative to an anchor point.

20. The device of claim 15, wherein the heave plate has a natural period that is at least 1.5 times higher than the period of the most prevalent wave at the site in which the device is deployed for at least one mode of motion.
